(19) United States
(12) Patent Application Publication
(10) Pub. No.: US 2020/0270884 A1
(43) Pub. Date: Aug. 27, 2020

(54) Cementitious-filler/coating repair system for commercial and residential panelized roofs

(71) Applicants: MARC ANDREW WINKELMAN, Chandler, AZ (US); James Paul Jenkins, Amity, OR (US); Landon Crittenden Haney, JR., McMinnville, OR (US)

(72) Inventors: MARC ANDREW WINKELMAN, Chandler, AZ (US); James Paul Jenkins, Amity, OR (US); Landon Crittenden Haney, JR., McMinnville, OR (US)

(21) Appl. No.: 16/282,180

(22) Filed: Feb. 21, 2019

(51) Int. Cl. E04G 23/02; C04B 28/04; C04B 24/26; C04B 18/02; C04B 26/16

(52) U.S. Cl. CPC E04G 23/0281; C04B 28/04; C04B 2111/40; C04B 18/027; C04B 26/16; C04B 24/2641

(57) ABSTRACT

The Invention is a filler/coating system with multiple formulations and mixtures designed to profile roof substrates in optimizing water shed drainage characteristics. These mixtures have a weight that is 50% of the weight of water. This weight reduction reduces the load on the existing roofing elements and allows for the optimized profiling of the slope of a roof without increasing the weight on the existing roof elements/members, this objective is met by the displacement of the water that normally fills and sits in the sagging ponding areas of a weakened and deteriorated roofing structure. The existing roofing elements need not be removed, torn off or repaired, as this system is designed to be an overlay filler/coating system that provides an ideal profiling slope of the roofs substrate for the application of a new water tight roofing membrane system to then be applied.

### CROSS-REFERENCE TO RELATED APPLICATIONS

Cross reference to provisional patent application No. 62/637,001.

### STATEMENT REGARDING FEDERALLY SPONSORED RESEACH

There is no federally sponsored research for this invention.

### BACKGROUND OF THE INVENTION

This invention relates specifically to various formulations for filler and coating repair system for the repair of commercial/residential roofs. The commercial/residential roofing industry is the field of endeavor that the invention pertains. Currently the commercial/residential roofing industry uses several methods/systems for the repair and maintenance of low sloped (flat) roofs. Currently across North America the majority of low sloped (flat) roofs are exhibiting one common problem of water “ponding”. This problem origins stem from the construction methods and materials used for building the structural framing on which the “deck” (plywood) is secured with a water tight roofing system, which is then applied to the deck. Ponding is a considerable problem across the industry and low-slope (flat) roofs create ideal conditions for ponding issues to occur. “Ponding” occurs when water does not completely drain off a roof within 24 hours following a rainfall. Untreated ponding creates further and continued weight bearing on the already sagging roof structure elements, which overtime produces further sagging and a deepening of the ponding areas. Ponding also provides the ideal conditions for vegetation, moss, mold and or mildew growth which are further elements of roof failures.

The problem of ponding is most widely seen on large low-slope (flat) commercial panelized type roofs. The roof framing is typically engineered and built with glulams (6¾″×33″×50-ft) on 20-ft centers, which run the length of the building. The purlins (4″×8″×20-ft) are installed between the glulams on eight ft centers, between the purlins there are sub-purlins (2″×4″×8-ft) installed on a two ft center between the purlins. Once the roof framing is built it is then decked with 4-ft×8-ft-½″ sheet of OSB plywood. This engineered structural roof framing design is thought to be strong and is supposedly designed to more than carry the loads that are anticipated to be placed upon it. The use of the ½″ sheet of OSB plywood is the major problem as the plywood cannot properly span the two feet between sub-purlins without resulting in a sagging of the plywood. There wouldn't be such a problem if thicker and non OSB type plywood was used, as it could span the two feet distance without ever sagging.

The sub-purlins (2″×4″×8-ft) framing members also tend to sag over the years leading to ponding i.e. the holding of water capacities that occur by design, which then contribute to increased loads which create further sagging thus creating increased ponding. The ponding primarily occurs in the two foot by eight-foot bays established between the pulins and the sub-purlins and primarily due to three main reasons. (1) The ½″ OSB plywood can almost immediately sag when placed on a span of a two-foot center. The sag problem is progressive with increased amounts of water held over years the sag increases (Poor structural framing design). (2) Over time with increased water weight being held in the two-foot bays the sub-purlins being sagging on the eight-foot lengths (Poor structural framing design). (3) Failure of the water tight integrity of the roofing membrane, which leads to increased loads on the two mentioned framing members due to becoming water logged/rotted, which further reduces their load carrying capacities.

The three most common repair methods for the weakened roofs as described are as follows:
1) The complete tear-off (removal) of the water tight roofing membrane system to make the complete removal and repairs of any structural framing members that are “sagging” followed by re-applying a water tight roofing membrane system. The invention stands to be unique in that it teaches that there is no need to remove nor repair the existing roof. The invention can simple be applied over the existing roof to resolve all and any ponding issues at great economic savings in both labor and materials in conjunction with quickened timeframe in the act of complete restoration of a roof with no inconvenience or interruption to the tenant/business occupying the building.
2) The complete tear-off (removal) of the just the water tight roofing membrane system of the roof followed by re-application of a new water tight roofing membrane system without the complete repairs of any structural framing members that are “sagging”. The method demonstrates the belief of the entity performing said repairs that ponding is not a structural problem if the water tight roofing membrane system has integrity. The roof might not leak but untreated ponding creates further and continued weight bearing on the already weakened/sagging roof structure elements, which overtime produces further sagging and a deepening of the ponding areas. The water shed drainage characteristics/profiling of a roofing system are a must in obtaining the maximum life expectancy of a roof both in terms of its water tight integrity and its performance in a structural capacity.
3) The repair of ponding areas of a roof without the complete tear-off (removal) of the water tight roofing membrane system or the complete removal and repairs of any structural framing members that are “sagging”. The repair of ponding areas of a roof are made with a slurry of a cement/mortar type mixture to re-profile the ponding areas. The slurry repair approach fills the pond but does so with an increased dead weight of more than double the weight of ponding water it displaced. This additional dead weight creates further and continued weight bearing on the already weakened/sagging roof structure elements, which overtime produces further sagging and a deepening of the ponding areas. The slurry repair approach will begin to crack once further sagging which leads to water intrusion/inundation of the slurry mixture filling the porosity/voids of the slurry mixture increasing the dead weight snowballing the “sagging” problem.

The invention teaches inexpensive and effective lightweight cementitious filler and coating system that does not require any tear-off of the old roofing system nor the replacement of any structural framing members. The invention eliminates the permanent dead-weight load-bearing problems for the already weakened roof. The invention reduces the total labor and materials cost for the complete re-roofing of a building at 35% to 55% the cost over the typical repair protocol currently being practiced.

### BRIEF SUMMARY OF INVENTION

The Invention is a lightweight filler/coating system with multiple formulations and mixtures designed to profile roof substrates in optimizing water shed drainage characteristics.
1. The Invention teaches two types of base formulations/mixtures:
   (a) An unconventional cement-based coating that exclusively utilizes light weight aggregates (perlite, vermiculite, or poly-styrofoam) instead of sand and gravel aggregates, which are more traditionally used in the formulations of cement-based mixtures. The current art formulates cement base mixtures that contain Portland cement, sand and of gravel. The invention teaches formulations containing only lightweight aggregates are to be utilized.
   (b) A urethane rubber-based coating that can that utilizes light weight aggregates (perlite, vermiculite, or poly-styrofoam)
   These various mixtures are used as an over-lay coating system that fills and levels the roof to ensure a consistent flat profile to provide the total run-off and drainage of all water.
2. These mixtures are formulated to provide an ideal substrate that accepts the application of all types of water tight roofing membrane and or applied coating systems to complete the installation of a water tight new roof.
3. The invention provides an extension of existing structural framing and water tight roofing systems through the methodology of revitalization by over-lay coatings. These coatings remove the standard industry protocol requirements for the tear-off, removal and or the repair of any existing roofing elements installed prior to the installation of a new water tight roofing membrane and or applied coating system.

### BRIEF DESCRIPTION OF THE DRAWINGS

FIG. 1 shows top-down overview of the structural framing elements of a low slope (flat) commercial panelized roof composition.

FIG. 2 shows side view cut away of a section of the elements of a repaired roof.

FIG. 3 top-down overview of a roof in various phases of completion.

### DETAILED DESCRIPTION OF THE INVENTION

The Invention is a coating/filler system with multiple formulations and mixtures designed to profile roof substrates in optimizing water shed drainage characteristics.

The Invention teaches two types of base formulations/mixtures:
(a) A cement-based coating that utilizes light weight aggregates (perlite, vermiculite, or poly-styrofoam) each of these aggregates can be used separately; one in place of another and or they can be combined and blended together as desired. The invention teaches the use of four basic types of these cement-based formulations/mixtures: (1) Fine aggregate mixes for thin skimmed applications. (2) Medium aggregate mixes. (3) Course aggregate mixes for thicker or deeper applications and (4) Blended mix formulations of the three aggregate sizes optimizing performance characteristics.
   These mixtures are formulated with the Portland cement that is utilized as the binding agent of the mixtures. The cement is mixed with an acrylic polymer to make a cement paste creating the consistency of a thin milkshake, to which the lightweight aggregate is added into and mixed thoroughly. There is no sand or gravel aggregates being utilized in these mixtures, instead the invention teaches the isolated use of lightweight aggregates of perlite, vermiculite, or poly-styrofoam. The volume measured ratios between the cement and the lightweight aggregate is taught by the invention to be adjustable to increase the strength and or the performance characteristics of a mixture formulation as needed or in contrast to be able to make lighter weight mixtures as may be required. The options of cement to the lightweight aggregate ratios are:
      1-Part cement to 2-parts aggregate.
      1-Part cement to 3-parts aggregate.
      1-Part cement to 4-parts aggregate.
      1-Part cement to 5-parts aggregate.
      1-Part cement to 6-parts aggregate.
(b) A urethane rubber-based coating that can that utilizes light weight aggregates (perlite, vermiculite, or poly-styrofoam) each of these aggregates can be used separately one in place of another and or they can be combined and blended together as desired. The invention teaches the use of four basic types of these cement-based formulations/mixtures: (1) Fine aggregate mixes for thin skimmed applications. (2) Medium aggregate mixes. (3) Course aggregate mixes for thicker or deeper applications and (4) Blended mix formulations of the three aggregate sizes optimizing performance characteristics.
   These mixtures are formulated with a two-part urethane rubber that is utilized as the binding agent of the mixtures. The rubber is mixed creating the consistency of a thin milkshake, to which the lightweight aggregate is added into and mixed thoroughly. There is no sand or gravel aggregates being utilized in these mixtures, instead the invention teaches the use of lightweight aggregates of perlite, vermiculite, or poly-styrofoam. The volume measured ratios between the rubber and the lightweight aggregate is taught by the invention to be adjustable to increase the strength and or the performance characteristics of a mixture formulation as needed or in contrast to be able to make lighter-weight mixtures as may be required. The ratios are:
      1-Part rubber to 2-parts aggregate.
      1-Part rubber to 3-parts aggregate.
      1-Part rubber to 4-parts aggregate.
      1-Part rubber to 5-parts aggregate.
      1-Part rubber to 6-parts aggregate.

The process for addressing the renewing or restoration of an existing roofing project is as follows:
1. Remove any debris and presser wash the entire roof. Vacuum or blow off any standing water and let roof fully dry.
2. Apply the proprietary Acrylic Bonding/Primer Agent of the invention to pretreat the roof. Don't apply the Acrylic Bonding Agent to the roof if the urethane rubber-based filler coating mixture is used, as it is an incompatible mix combination.
3. Mix the filler coating mixture with the proprietary Acrylic Admixture to a consistency of a thin milkshake and apply to screed/level out any low-lying areas of the project and let dry. If the cement-based filler coating mixture is used allow an overnight dry time. If the urethane rubber-based filler coating mixture is used allow one hour to dry.
4. Apply the water tight roofing system of your choice providing that it is a textile membrane reinforced based system.

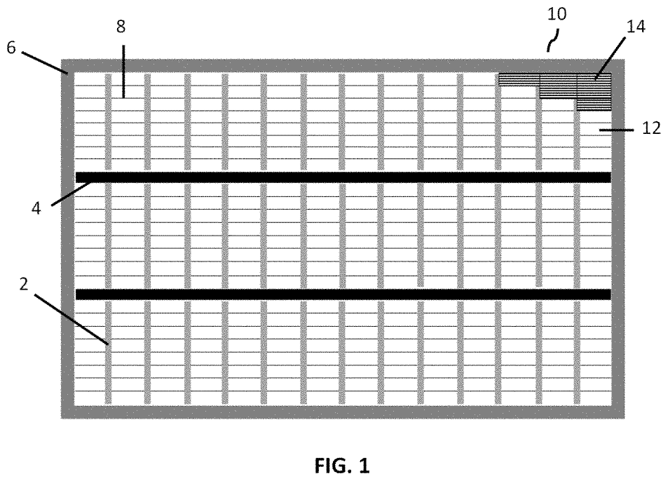

FIG. 1 shows top-down overview of the structural framing elements 10 of a commercial panelized roof composition. The roof is first constructed with the placement of the glulams 4 which typically have the dimensions of (6¾″×33″×50-ft) and are placed on 20-ft centers, which run the length of the building 6. The purlins 2 which have the typical dimensions of (4″×8″×20-ft) are installed next between the glulams 4 and are placed on eight ft centers. Then installed between the purlins 2 there are sub-purlins 8 which have the typical dimensions of (2″×4″×8-ft) and are installed on a two ft center between the purlins 2. Once the roof framing 10 is built it is then decked with 4-ft×8-ft−½″ sheet of OSB plywood 14.

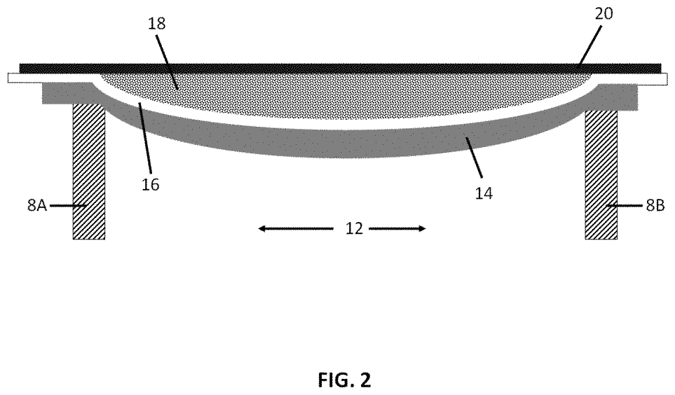

FIG. 2 shows side view cut away of a section of a 2-ft×8-ft bay 12 that is decked with ½″ sheet of OSB plywood 14. The sub-purlins 8A and 8B are shown to be at a span of 2 feet and the ½″ sheet of OSB plywood 14 is sagging as is the typical condition/problem experienced in the field. The existing ½″ sheet of OSB plywood 14 has the old existing water tight roofing membrane system 16 installed and it also is sagging the same as the ½″ sheet of OSB plywood 14. The filler coating 18 is applied to level the void to which the new water tight roofing membrane system 20 is now applied and the roof repair/renewal are complete.

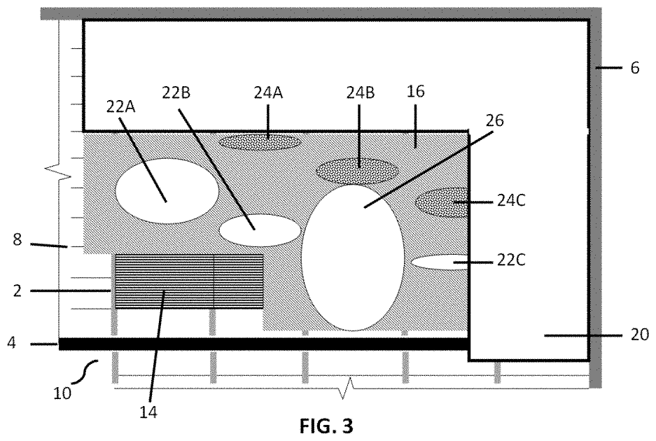

FIG. 3. Top-down overview of the corner section of the building 6 and the roof in various materials layered in staged phases of completion. The glulams 4, purlins 2, sub-purlins 8, the ½″ plywoodl4 and the old existing water tight roofing membrane system 16.

FIG. 3. A further illustration of existing ponding 22b and 22c that are confined to the 2 ft by 8 ft bays 12, whereas the existing pond 22A is confined to two of the 2 ft by 8 ft baysl2 because the 2″×4″ sub-purlin 8 that separate the two bays 12 is also sagging along with the ½″ plywood 14.

FIG. 3. A further illustration of the pond 26 covers three of the 2 ft by 8 ft bays 12 because two of the 2″×4″ sub-purlins 8 that separate the three bays 12 are also sagging along with the ½″ plywood14.

FIG. 3. A further illustration of filler coating being applied to level the ponds 24a, 24b and 24c with the new water tight roofing membrane system 20 being installed

We claim:

1. These formulated filler coating mixtures are the only roofing systems on the market that utilize a cement based ultra lightweight mixture that is formulated with absolutely no sand or gravel aggregates in which the said mixtures are used to fill and or coat an existing roofing to profile the roof to correct improper water shed drainage characteristics, which then allows a new water tight roofing membrane system to be installed.

2. These formulated filler coating mixtures are the only roofing systems on the market that utilize a urethane rubber based ultra lightweight mixture that is formulated with lightweight aggregates in which the said mixtures are used to fill and or coat an existing roofing to profile the roof to correct improper water shed drainage characteristics, which then allows a new water tight roofing membrane system to be installed.
